(19) United States
(12) Patent Application Publication
(10) Pub. No.: US 2016/0032898 A1
(43) Pub. Date: Feb. 4, 2016

(54) GENERATOR TEST BENCHES AND BACK-TO-BACK TESTING SYSTEMS AND METHODS

(71) Applicant: ALSTOM RENEWABLE TECHNOLOGIES, Grenoble (FR)

(72) Inventor: Josep PRATS MUSTAROS, Barcelona (ES)

(21) Appl. No.: 14/777,419

(22) PCT Filed: Mar. 26, 2014
(86) PCT No.: PCT/EP2014/056050

§ 371 Date: Sep. 15, 2015

(30) Foreign Application Priority Data
Mar. 27, 2013 (EP) 13382121.5

(51) Int. Cl. F03D 11/00

(52) U.S. Cl. CPC F03D 11/0091

(57) ABSTRACT

Generator test benches and back-to-back testing systems and methods are disclosed. A test bench (110) may comprise a single fixed structure and a shaft (132). The single fixed structure may include a common base (160) fixed to the ground and a hollow body (115) with a central pillar (117) connecting them. The shaft may be arranged inside the hollow body and may have a first end extending beyond a first opening and a second end extending beyond a second opening of the hollow body. The shaft may be connectable to rotors (124A, 124B) of two generators (120A, 120B). The single fixed structure may be connectable to the stators of the generators (122A, 122B).

This application claims the benefit of European Patent Application EP13382121 filed 27 Mar. 2013.

The present disclosure relates to electricity generators and more particularly to test benches for testing generators as well as to methods and systems of back-to-back testing of electricity generators.

### BACKGROUND ART

Electricity generators, such as wind turbine generators, may require extensive testing before being deployed at an electricity generation plant, such as a wind turbine. One known way of testing generators is in a back-to-back testing system. In typical back-to-back testing systems two generators are mounted on a testing configuration known as a test bench. In a back-to-back arrangement, one generator functions as a drive motor and the other as a generator. The two generators are mechanically coupled via, e.g., a shaft. The power produced by the generator is “given back” to the supply of the drive motor. In this way the only power required is the power to compensate for the losses during the testing process.

Typically, a back-to-back test bench includes separate supports for each of the generators and a coupling between them. Each support is typically attached at one end to the stator of the respective generator and at the other end it is fixed to the ground. A shaft between the two generators is used for transmitting torque from the first generator to the second generator.

When the first generator is arranged in a motor configuration, the shaft transmits torque from the rotor of the first generator to the rotor of the second generator. However, as the rotors rotate, each generator transmits torque to the foundation of its respective support. This implies that the supports are subjected to great loads during testing mode. Therefore, the respective supports have to be designed strong enough to withstand such loads. As a consequence, manufacturing cost is significant both in terms of body of material as well as in terms of selecting the appropriate material to provide the required structural integrity. Another problem that these test benches face is that it can be difficult to align the two generators. The respective supports must be perfectly aligned with each other and with the shaft. Even minor misalignments may cause undesired vibration and loads during testing that may affect the test results, and/or the integrity of the test bench and may even damage the generators.

### SUMMARY OF THE INVENTION

There is a need for a new test bench that at least partially resolves some of the above mentioned problems. It is an object of the present invention to fulfill such a need.

In a first aspect of the invention a generator test bench for a back-to-back testing system is disclosed. The test bench may comprise a fixed structure and a shaft. The fixed structure may comprise a common base fixed to the ground, a hollow body and a central pillar. The hollow body may have a first opening and a second opening. The central pillar may connect the common base with the hollow body. The shaft may be arranged inside the hollow body and may have a first end extending beyond the first opening and a second end extending beyond the second opening. The first end of the shaft may be connectable to a first rotor of a first generator and the second end of the shaft may be connectable to a second rotor of a second generator. The fixed structure may be connectable to the stators of said first and second generators. The shaft may be supported directly by the fixed structure by bearings.

By providing a common base to the test bench, the torque that would otherwise be transmitted to the ground (and foundation) may now be transmitted directly to the other generator through the common base. Therefore the test bench requires less reinforcement than otherwise as substantially less torque is transmitted to the ground.

By arranging the shaft inside the hollow body the alignment process is very easy as the rotors of the generators are directly attached at the ends of the shaft and any deformation of the test bench structure may be applied to all the components at the same time.

In some embodiments, the first opening may define a first flange and the second opening may define a second flange, the first flange being connectable to the stator of the first generator and the second flange being connectable to the stator of the second generator. The shaft may be arranged to traverse a space in the center of each generator.

By arranging the shaft to traverse a space in the center of the generators, it is possible to couple the shaft to the generator rotors from the external sides of the back to back arrangement, i.e. the sides facing away from the hollow body. In these embodiments no torque may be transmitted to the ground as the stators are attached to the same hollow structure of the shaft, yet from opposite sides. As a consequence the torque of one generator may be counter-acted by the torque of the other generator, and vice versa. Furthermore, such an arrangement may allow minimization of the size of the test bench, as the loads transmitted to the foundations are minimized. It further may allow for a compact test bench that may be transportable. This has the benefit that the test benches may be manufactured at one site and be moved closer to the actual operating site for testing. Such a process can provide significant savings in terms of transportation and operational costs.

In some embodiments, the hollow body may be cylindrical. This may facilitate coupling of the hollow body to the stators, as stators typically tend to be arranged in a circular configuration. The test bench may then further comprise at least a bearing inside the hollow body for coupling the shaft to the hollow body. This may ensure that the shaft remains concentric with the hollow body and may mitigate the loads on the shaft from the two ends to the whole surface of the hollow body.

In some embodiments, the test bench may further comprise a first shaft connector coupled at a first point to the first end of the shaft and a second shaft connector coupled at a first point to the second end of the shaft. The first and second shaft connectors may be connectable to the first and second rotors, respectively, at a second point. Furthermore, the shaft connectors may also comprise an elastic coupling for providing the shaft connectors with resiliency. Elastic shaft connectors may reduce the transmission of bending loads from the shaft to the generators and vice versa.

In another aspect of the invention a back-to-back (B2B) testing system is disclosed. The B2B testing system may comprise a test bench according to any of the embodiments hereinbefore described, a pair of converters, each arranged to be electrically connectable to a generator. The B2B testing system may further comprise a first generator, arranged in a motor configuration, a slip ring for transmitting the torque of the first generator to the shaft and a second generator arranged in a generator configuration. The generators may be direct-drive generators and each may comprise a central space. The converters may be coupled through a transformer. The transformer may be used to stabilize the input voltage of the first generator. The converters may be power electronic converters. The use of power electronic converters may further reduce the size of the back-to-back system. The back-to-back system may further include a controller for controlling at least speed and torque of the generators.

An advantage of arrangements according to the invention is that the load path between both generator, both for the stator connection and the rotor connection may be very short resulting in higher stiffness and improved dynamics for the whole arrangement.

In another aspect of the invention a method of testing generators in a back-to-back testing system is disclosed. In a first step a first generator may be mounted on a test bench according to the first aspect of the invention. Next, a second generator may be mounted on the test bench. In a third step, the first generator may be driven as a motor. Finally, the second generator may be tested. When the testing of the second generator has been concluded, the roles of the first generator and the second generator may be exchanged, i.e., the second generator may be driven as a motor so that the first generator may be tested.

The method has the advantage that the use of a test bench allows for easy mounting and unmounting of the generators without requiring rigorous alignment processes. Consequently, the time required to set up the testing process is minimized.

In some embodiments, the method may further comprise the steps of providing information from a set of sensors installed in both generators, selecting a pre-established pattern of testing and testing the generators in response to said information provided and said selected pre-established pattern.

This ensures minimum intervention from the test personnel as the whole testing process is automated.

In some embodiments, the method may further comprise gathering test result information by sensors in the generators and storing said test result information as a footprint of the tested generator. The test result information may include at least one of instantaneous speed, power, voltage, current, airgap, vibration or temperature of the tested generator. The footprint of the tested generator may then be used during installation and maintenance to optimize the operational parameters of the generator when the generator is deployed in production.

### BRIEF DESCRIPTION OF THE DRAWINGS

Particular embodiments of the present invention will be described in the following by way of non-limiting examples, with reference to the appended drawings, in which:

FIG. 1 shows a B2B arrangement for direct drive generators of a first type according to an implementation.

FIG. 1A shows a B2B arrangement for direct drive generators of the first type according to a second implementation.

FIG. 2 shows a B2B arrangement for direct drive generators of a second type according to a third implementation.

### DETAILED DESCRIPTION OF EMBODIMENTS

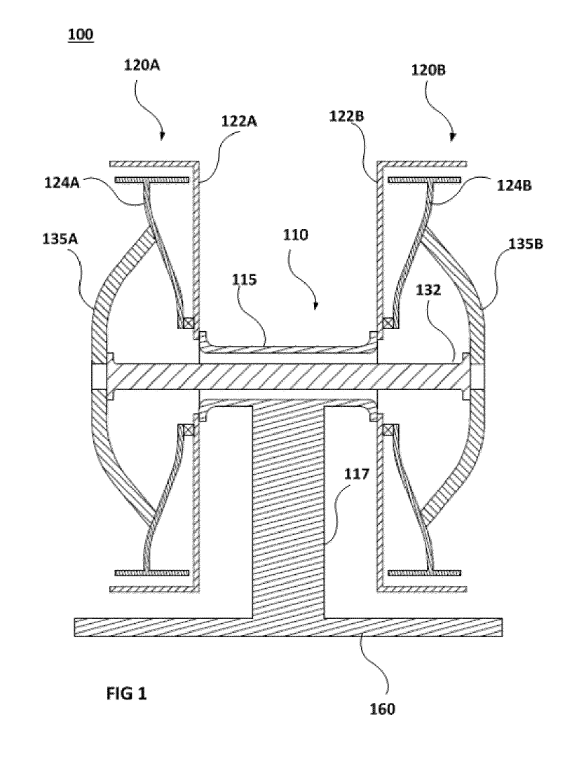

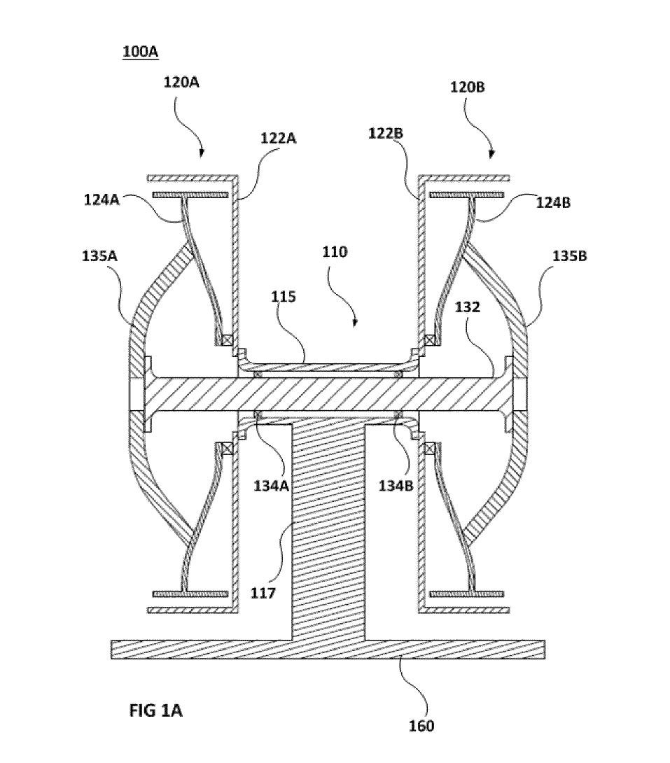

FIG. 1 shows a B2B arrangement according to an implementation. B2B arrangement 100 may comprise a test bench 110, a first generator 120A and a second generator 120B. The two generators may be of a first direct-drive type, i.e. in normal use they may be directly driven.

The direct drive generators of the first type may be disc shaped with concentric stator and rotor and may comprise a central hole in the center. The stators in the first type direct-drive generators remain fixed around rotating rotors 124A, 124B. Each generator may be connected to a converter (not shown), the converters being connected via a common transformer (not shown). The first generator 120A may be driven as a motor. The rotors of the two generators may be mounted so that their sides are not facing each other.

The test bench 110 may comprise a common base 160, a hollow body 115, a support pillar 117 between the common base 160 and the hollow body 115, and a shaft 132. A pair of connectors 135A, 135B may couple the shaft with the generators. The hollow body 115 may be arranged between the stators 122A, 122B of the generators 120A and 120B, respectively. The hollow body 115 may be shaped as a hollow cylinder. The one side of the hollow body 115 may be fixed to the stator 122A of the first generator 120A. The other side of the hollow body may be fixed to the stator 122B of the second generator 120B. The shaft 132 may traverse and extend beyond either side of the hollow body 115 and from the central holes of the two generators.

A first connector 135A may be attached at one end of shaft 132 at a first point. The one end of shaft 132 may be attached, for example, to the inner center of connector 135A, as shown in FIG. 1. The first connector 135A may be flexibly attached at a second point, or at a plurality of points, to the rotor 124A of the first generator 120A. Accordingly, a second connector 135B may be attached at the other end of shaft 132 at a first point. The other end of shaft 132 may be attached, for example, to the inner center of connector 135B, as shown in FIG. 1. The second connector 135B may be flexibly attached at a second point, or at a plurality of points, to the rotor 124B of second generator 120B.

During a back-to-back testing process, the rotor 124A of the first generator 120A starts rotating in a first direction and transmits torque via the stator 122A to the hollow body 115. As the shaft 132 rotates, the rotor 124B of second generator 120B starts to rotate and transmits torque via the stator 122B to the hollow body 115. From a certain point of view, one end of shaft 132 may be considered to rotate clockwise and the other anticlockwise. Accordingly, one rotor may rotate clockwise and the other anticlockwise. Consequently, the torque applied to the first generator is opposite to the torque applied to the second generator. Therefore, the resulting torques are offset and negligible or no torque at all is transmitted to the foundations or to the ground via the common base.

Furthermore, mounting and alignment of the two generators is very easy. First the stators 122A, 122B may be fixed to the hollow body 115 independently. Then the shaft may be introduced in the central hole of one of the generators, passes through the hollow body and through the hole of the second generator. Finally, the rotors may be flexibly attached to the shaft 132 with the connectors 135A, 135B. The test bench 110 of FIG. 1 is compact and requires significantly less material compared to the prior art, as no torque is transmitted to the ground. Therefore the loads are distributed between the two generators and the efficiency of the testing process can be maximized.

FIG. 1A shows a B2B arrangement similar to the one in FIG. 1, with the only difference that a pair of bearings 134A, 134B is arranged inside the hollow body 115, between the shaft 132 and the inner surface of the hollow body 115. The purpose of the bearings is to mitigate any oscillations caused by the first generator 120A to pass to the second generator 120B via the shaft 132. Furthermore, it facilitates mounting of the generators 120A, 120B as the shaft 132 may be introduced in the hollow body before mounting of the stators because the shaft is retained in the center of the hollow body 115 by the bearings 134A, 134B. Additionally, the loads of the generators on the hollow body 115 due to their weight and torque are more evenly distributed along the hollow body.

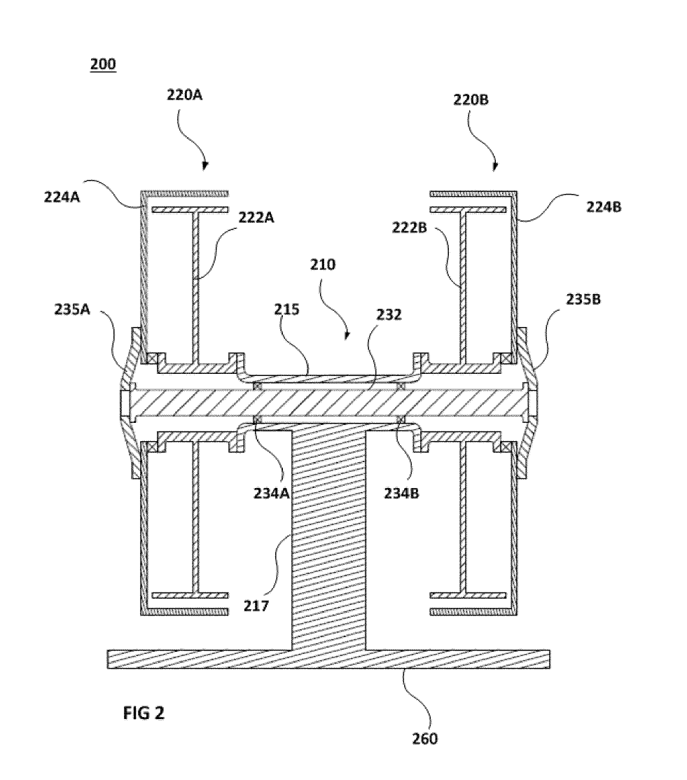

FIG. 2 shows a B2B arrangement for direct drive generators of a second type according to an implementation. The direct drive generators of the second type may also be disc shaped with concentric stator and rotor. In the second type generators, the rotor (224A, 224B) may rotate around the stator (222A, 222B).

A test bench 210 comprises a hollow body 215, a common base 260, a central pillar 217 connecting the hollow body 215 with the common base 260, and a shaft 232. The one side of the hollow body 215 may be fixed to the stator 222A of the first generator 220A. The other side of the hollow body may be fixed to the stator 222B of the second generator 220B. The shaft 232 may traverse and extend beyond either side of the hollow body 215 and from the central holes of the two generators 220A, 220B.

A first connector 235A may be attached at one end of shaft 232 at a first point. The one end of shaft 232 may be attached to the center of the first connector 235A. The first connector 235A may be flexibly attached at a second point, or at a plurality of points, to the rotor 224A of first generator 220A. Accordingly, a second connector 235B may be attached at the other end of shaft 232 at a first point. The other end of shaft 232 may be attached to the center of the second connector 235B. The second connector 235B may be flexibly attached at a second point, or at a plurality of points, to the rotor of second generator 220B. A pair of bearings 234A, 234B may be arranged inside the hollow body 215, between the shaft 232 and the inner surface of the hollow body 215, similarly to the embodiment of FIG. 1A.

The B2B arrangement of FIG. 2 functions in the same way as the arrangements of FIG. 1 and FIG. 1A. During a B2B testing process, the resulting torques are offset for the same reasons given with reference to FIG. 1. Accordingly, the mounting process ensures that the two generators are aligned.

The connectors shown in FIG. 1-2, are mere examples of connectors between a shaft and a rotor. Any suitable type of connector may be used for coupling the shaft with the rotors provided that the coupling between the connector and the rotor has a certain elasticity that allows smooth transfer of torque from the shaft to the rotor or from the rotor to the shaft.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

1. A generator test bench, comprising:
(i) a fixed structure, having
a common base fixed to a ground;
a hollow body, having a first opening and a second opening;
a central pillar connecting the common base with the hollow body;
(ii) a shaft, arranged inside the hollow body, having a first end extending beyond the first opening and a second end extending beyond the second opening,
wherein the first end of the shaft is connectable to a first rotor of a first generator and the second end of the shaft is connectable to a second rotor of a second generator, and
wherein the fixed structure is connectable to stators of the first and second generators.

2. The test bench according to claim 1, wherein the first opening defines a first flange and the second opening defines a second flange, the first flange being connectable to the stator of the first generator and the second flange being connectable to the stator of the second generator.

3. The test bench according to claim 2, wherein each generator has a center and the shaft is arranged to traverse a space in the center of each generator.

4. The test bench according to claim 1, wherein the hollow body is at least partially cylindrical.

5. The test bench according to claim 4, further comprising at least one bearing inside the hollow body for coupling the shaft to the hollow body.

6. The test bench according to claim 1, further comprising:
a first shaft connector coupled at a first point to the first end of the shaft, and
a second shaft connector coupled at a first point to the second end of the shaft,
wherein the first and second connectors are connectable to the first and second rotors, respectively, at a second point.

7. A back-to-back testing system comprising:
a test bench comprising:
(i) a fixed structure, having
a common base fixed to the ground;
a hollow body, having a first opening and a second opening;
a central pillar connecting the common base with the hollow body;
(ii) a shaft, arranged inside the hollow body, having a first end extending beyond the first opening and a second end extending beyond
the second opening, and
a pair of converters, each arranged to be electrically connectable to a generator,
wherein the first end of the shaft is connectable to a first rotor of a first generator and the second end of the shaft is connectable to a second rotor of a second generator, and
wherein the fixed structure is connectable to stators of the first and second generators.

8. The back-to-back testing system according to claim 7, wherein the converters are power electronic converters.

9. The back-to-back testing system according to claim 7, further comprising a controller, adapted to control at least a speed and a torque of the generators.

10. A first generator and second generator in combination with the back-to-back testing system according to claim 7, further comprising:
the first generator arranged in a motor configuration, the first rotor being connected to the first end of the shaft;
a slip ring for transmitting a torque of the first generator to the shaft; and
the second generator arranged in a generator configuration, the second rotor being connected to the second end of the shaft.

11. The combination first and second generators and back-to-back testing system according to claim 10, wherein the generators are direct-drive generators and each comprises a central space.

12. The combination first and second generators and back-to-back testing system according to claim 10, wherein the rotors of the generators are flexibly coupled to the shaft.

13. A method of testing generators in a back-to-back testing system, the back-to-back testing system having a test bench and a pair of converters, the test bench comprising:
(i) a fixed structure, having
a common base fixed to the ground;
a hollow body, having a first opening and a second opening;
a central pillar connecting the common base with the hollow body; and
(ii) a shaft, arranged inside the hollow body, having a first end extending beyond the first opening and a second end extending beyond the second opening, and
a pair of converters, each arranged to be electrically connectable to a generator, the method comprising:
mounting a first generator on the test bench;
mounting a second generator on the test bench;
driving the first generator as a motor; and
testing the second generator.

14. The method according to claim 13, further comprising:
driving the second generator as a motor;
testing the first generator.

15. The method according to claim 13, further comprising:
providing information received from a set of sensors installed in both generators;
selecting a pre-established pattern of testing;
testing the generators in response to the information provided and the selected pre-established pattern.

16. The method according to claim 15, further comprising:
gathering test result information from the sensors in the tested generators, the test result information including at least one of instantaneous speed, power, voltage, current, airgap, vibration or temperature of the tested generator; and
storing the test result information as a footprint of the tested generator.

17. The combination first and second generators and back-to-back testing system according to claim 10, wherein the first opening defines a first flange and the second opening defines a second flange, the first flange being connected to a stator of the first generator and the second flange being connectable to a stator of the second generator.

18. The combination first and second generators and back-to-back testing system according to claim 10, wherein the hollow body is at least partially cylindrical and the test bench further comprises at least one bearing inside the hollow body for coupling the shaft to the hollow body.

19. The combination first and second generators and back-to-back testing system according to claim 10, wherein the test bench further comprises:
a first shaft connector coupled at a first point to the first end of the shaft, and
a second shaft connector coupled at a first point to the second end of the shaft,
wherein the first and second connectors are connectable to the first and second rotors, respectively, at a second point.
